(19) United States
(12) Patent Application Publication
(10) Pub. No.: US 2013/0130114 A1
(43) Pub. Date: May 23, 2013

(54) NON-AQUEOUS ELECTROLYTE SECONDARY BATTERY

(71) Applicants: Yusuke Ohno, Hitachinaka (JP); Yoshihisa Okuda, Mito (JP)

(72) Inventors: Yusuke Ohno, Hitachinaka (JP); Yoshihisa Okuda, Mito (JP)

(73) Assignee: HITACHI VEHICLE ENERGY, LTD., Hitachinaka-shi, Ibaraki (JP)

(21) Appl. No.: 13/813,309

(22) PCT Filed: Jul. 30, 2010
(86) PCT No.: PCT/JP2010/004842

§ 371 Date: Jan. 30, 2013

(51) Int. Cl. H01M 4/583

(52) U.S. Cl. CPC H01M 4/583
USPC 429/231.1; 427/122

(57) ABSTRACT

A non-aqueous electrolyte secondary battery comprising amorphous carbon as a main agent of a negative electrode active material and having high energy density, less degradation of capacity during storage in a charged state, and excellent in cycle life characteristics is provided.

The negative electrode active material comprises a mixture of easily graphitizable carbon, less graphitizable carbon, and graphite, the mixture comprising composite particles having a structure where less graphitizable carbon is deposited to the surface of particles of easily graphitizable carbon and graphite. Particularly, it is preferred that the ratio of the less graphitizable carbon content relative to the total weight of the mixture is from 0.5 to 7%, the ratio of graphite content relative to the total weight of the mixture is from 5 to 20% in which the less graphitizable carbon is present at the surface of particles of easily graphitizable carbon by a mechanochemical treatment.

### TECHNICAL FIELD

The present invention concerns a non-aqueous electrolyte secondary battery using a carbon material as a negative electrode active material.

### BACKGROUND ART

In non-aqueous electrolyte secondary batteries in an initial stage, metallic lithium or alloys, for example, of lithium and lead have been used as the negative electrode active material but such batteries involve a problem in view of safety, for example, that dendritic metal lithium is deposited on the surface of a negative electrode during repeating charge/discharge cycles to cause internal short-circuit that may result in heat generation or ignition. Then, carbon materials have now been used instead of metallic lithium or alloys, for example, of lithium and lead as the negative electrode active material. As the carbon material capable of occluding and releasing lithium ions, a highly crystalline graphite powder (also including those similar therewith) or an amorphous carbon powder of lower crystallinity than that of the graphite powder has been used generally (for example, refer to Japanese Unexamined Patent Application Publication No. H11-339795: Patent literature 1).

### CITATION LIST

### Patent Literature

Patent literature 1: Japanese Unexamined Patent Application Publication No. H11-339795

### SUMMARY OF THE INVENTION

### Technical Problem

A secondary battery using the graphite powder as the negative electrode active material also involves a drawback shown below. That is, when the graphite powder is used, since the negative electrode is packed at a high density, there is less space for possessing an electrolyte, which worsens the diffusion of lithium ions during charge/discharge reaction. Particularly, at high rate discharge, an overvoltage increases to lower the discharge voltage. Further, when the graphite powder is used, since volume expansion/shrinkage accompanying occlusion/release of lithium ions is larger than that of the amorphous carbon powder, the carbon structure tends to be collapsed due to high rate charge/discharge cycles to result in a problem of shortening the cycle life in view of characteristics.

### Solution to Problem

For solving the subject, the present invention has a feature of including a negative electrode active material comprising a mixture of easily graphitizable carbon, less graphitizable carbon, and graphite, that is, composite particles of a structure in which less graphitizable carbon is deposited on the surface of easily graphitizable carbon particle and graphite.

The negative electrode active material preferably comprises mainly easily graphitizable carbon in which the content of the graphite ratio relative to the total weight of the mixture is from 1 to 30 mass parts and, particularly, 5 to 20 mass parts. Further, less graphitizable carbon is preferably mixed by 0.5 to 10 mass parts based on the total weight of the mixture. Particularly, the ratio of less graphitizable carbon to easily graphitizable carbon (weight of less graphitizable carbon weight/weight of easily graphitizable carbon weight) is 10% or less.

As the composite particles, those formed by subjecting easily graphitizable carbon and less graphitizable carbon to a mechanochemical treatment can be used.

### Advantageous Effects of Invention

It is possible to provide a non-aqueous electrolyte secondary battery comprising amorphous carbon as a negative electrode main agent, having a high energy density, with less deterioration of capacity during storage in a charged state, and having long cycle life in repeating charge/discharge cycles.

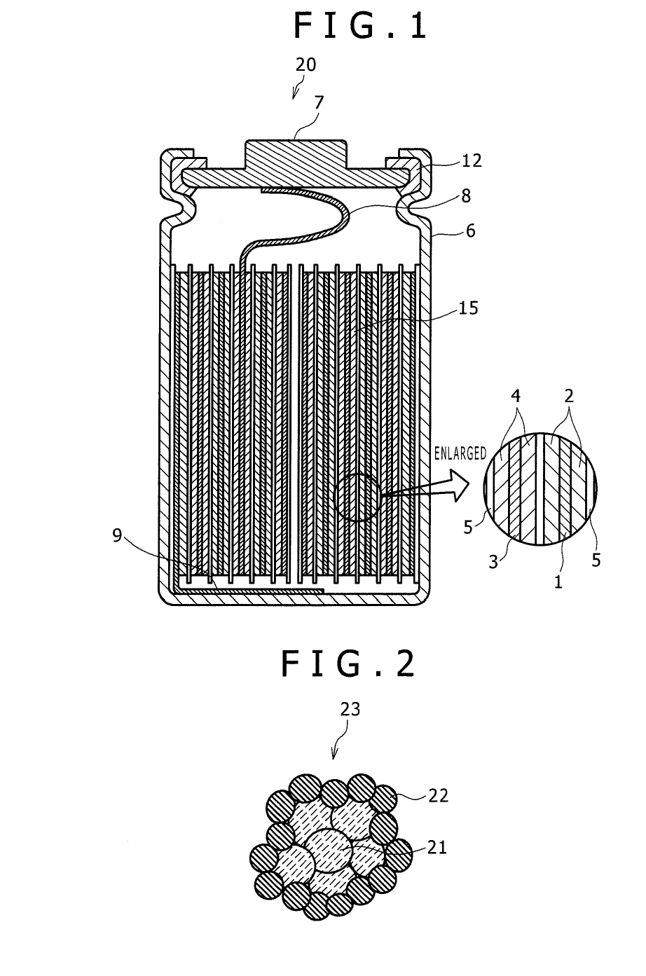

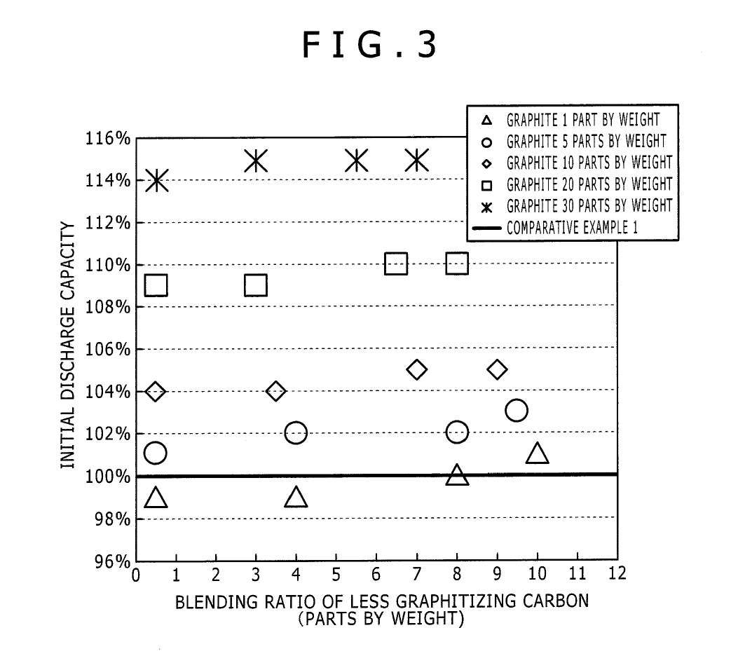

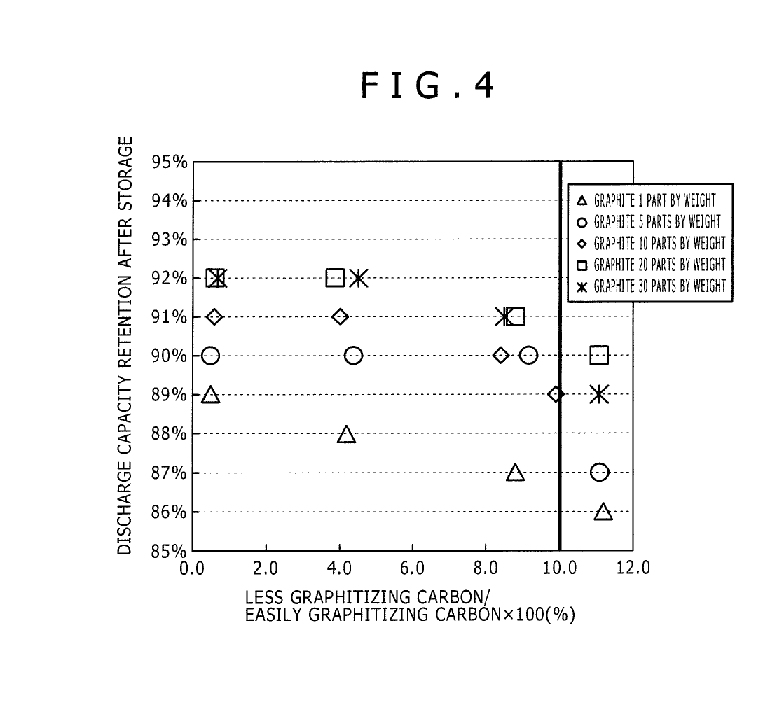

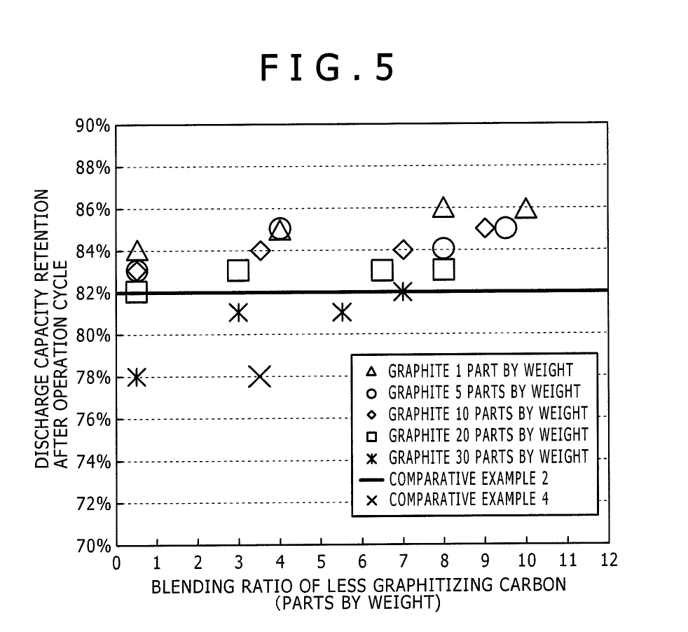

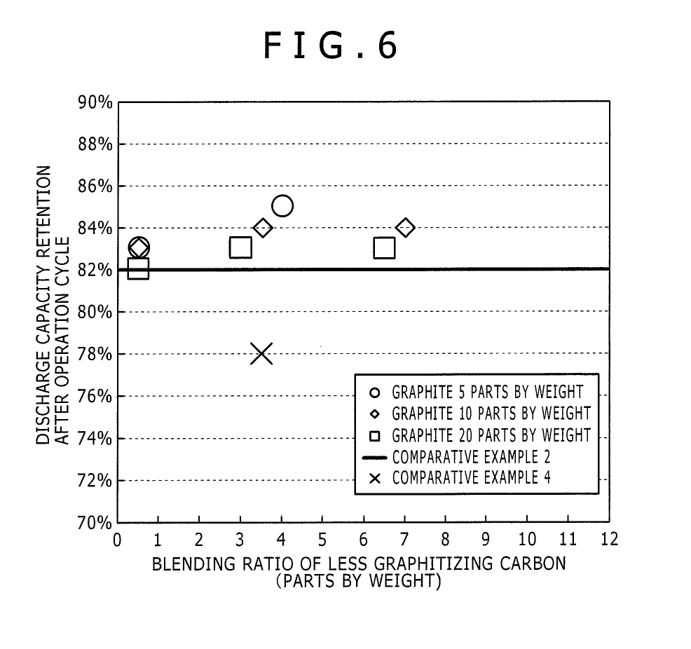

### BRIEF DESCRIPTION OF DRAWINGS

[FIG. 1] is a cross sectional view of a non-aqueous electrolyte secondary battery.

[FIG. 2] is a conceptional view of a composite powder 23 in which less graphitizable carbon 22 is subjected to a mechanochemical treatment to easily graphitizable carbon 21.

[FIG. 3] shows plots of charge capacity relative to a blending ratio of less graphitizable carbon.

[FIG. 4] shows plots of capacity retention after storage relative to the ratio of less graphitizable carbon and easily graphitizable carbon.

[FIG. 5] shows plots of capacity retention after operation cycles relative to the blending ratio of less graphitizable carbon.

[FIG. 6] shows plots of capacity retention after operation cycles of examples showing high characteristics in evaluation 1, evaluation 2, and evaluation 3.

### DESCRIPTION OF EMBODIMENTS

As the negative electrode active material, a carbon material is used and, particularly, a graphite powder, and an amorphous graphite powder have been investigated. The negative electrode active material comprises a mixture easily graphitizable carbon, less graphitizable carbon, and graphite in which the content ratio of less graphitizable carbon to the total weight of the mixture is from 0.5 to 7%, the content ratio of graphite to the total weight of the mixture is 5 to 20%, and less graphitizable carbon is present at the surface of easily graphitizable carbon by a mechanochemical treatment.

A non-aqueous electrolyte secondary battery using a highly crystalline graphite powder has advantageous features as shown below. That is, since the true density of the graphite powder is high, the packing density of the active material can be increased and, as a result, energy density of the non-aqueous electrolyte secondary battery can be increased. Further, an electrolyte is less decomposed at the first charge/discharge cycle and a coulomb efficiency is high just after the manufacture of the battery. Accordingly, the battery using the graphite powder as the negative electrode active material has an advantage that the energy density is high. Further, it is excellent also in a capacity retention property in a charged state.

However, the battery using the graphite powder as the negative electrode active material has a drawback as shown below. That is, when the graphite powder is used, since it is packed at a high density, there is less space to possess the electrolyte and the diffusion of lithium ions during charge/discharge reaction is worsened and, particularly, an overvoltage increases in high rate discharge to lower the discharge voltage. Further, when the graphite powder is used, since volumic expansion/shrinkage accompanying occlusion/release of lithium ions is larger than that of the amorphous carbon powder, a carbon structure tends to be collapsed due the high rate charge/discharge cycles to result in a problem that the cycle life is short in view of characteristic.

On the other hand, when the amorphous carbon powder is used as the negative elective material, since volumic expansion/shrinkage accompanying occlusion/release of the lithium ions is smaller than that of the graphite powder, it has an advantageous that the carbon structure is less collapsed by the high rate discharge and the cycle life is longer. However, since the amorphous carbon powder has a low true density, the packing density is low and, as a result, it is difficult to increase the energy density of the non-aqueous electrolyte secondary battery. Further, it has a drawback that the coulomb efficiency during the first charge/discharge cycle just after the manufacture of the battery is low.

Amorphous carbon includes less graphitizable carbon that is less graphitizable (hard carbon) and easily graphitizable carbon easily graphitizable (soft carbon) when heated at 2,000 to 3,000° C. Since easily graphitizable carbon has high coulomb efficiency and high packing density, a battery of high energy density can be provided as the non-aqueous electrolyte secondary battery using the amorphous carbon as the negative electrode. Further, the capacity retention in the charged state is excellent. However, compared with less graphitizable carbon, the amount of lithium ions that can be occluded is small and the cycle life due to repeating charge/discharge is short. On the other hand, since less graphitizable carbon shows less structural change due to occlusion/release of the lithium ions, the cycle life is excellent.

In view of the above, the present inventors intend to cover the surface of easily graphitizable carbon with less graphitizable carbon by a mechanochemical treatment thereby improving the cycle life of easily graphitizable carbon. Further, the amount of lithium ions that can be occluded is increased by incorporating graphite in the negative electrode mix, and the capacity retention in the charged state can be improved further. As a result, the battery comprises amorphous carbon as a main ingredient of the negative electrode and has high energy density, as well as the capacity retention is excellent even during storage in the charged state and the cycle life due to repeating charge/discharge can also be improved.

Easily graphitizable carbon is prepared by various methods and can be obtained from carbon materials formed by baking, for example, petroleum pitch, polyacene, polysiloxane, polyparaphnylene, and polyfurfuryl alcohol at about 800° C. to 1,000° C. Further, less graphitizable carbon is obtained from carbon materials formed by baking, for example, petroleum pitch, polyacene, polysiloxane, polyparaphenylene, and polyfurfuryl alcohol at about 500° C. to 800° C. Graphite is a natural product and can be obtained also by baking a starting material that is graphitizable by baking at a high temperature (easily graphitizable carbon).

Description is to be made more specifically with reference to the drawings. FIG. 1 shows an example of a 18650 type non-aqueous secondary battery 20. A positive electrode formed by coating a positive electrode assembly 1 with a positive electrode active material 2 and a negative electrode formed by coating a negative electrode assembly 3 with a negative electrode active material 4 are wound by way of a separator 5 to prepare an electrode group 15. The electrode group 15 is inserted into a battery can 6 and an electrolyte

Cycle life characteristics of less graphitizable carbon are more excellent than the cycle life characteristics of easily graphitizable carbon and graphite. The capacity retention after a cycle life characteristic test of easily graphitizable carbon and graphite is about 60 to 70% of that of less graphitizable carbon. On the other hand, the capacity during storage in the charged state of less graphitizable carbon tends to be degraded more than that of easily graphitizable carbon and graphite, and the capacity retention of less graphitizable carbon is about 70 to 80% of the materials described above. Accordingly, it is necessary to attain high cycle life characteristics and storage characteristics in the charged state by combining them. Therefore, as the negative electrode active material of the secondary battery, a mixture of easily graphitizable carbon, less graphitizable carbon, and graphite in which easily graphitizable carbon 21 and less graphitizable carbon 22 are present being subjected to a mechanochemical treatment is used so as to bring out advantageous features inherent to each of them. Easily graphitizable carbon and less graphitizable carbon are formed into a joined body by the mechanochemical treatment. As shown in FIG. 2, by forming joined body particles in which less graphitizable carbon is deposited on the surface of the particles of easily graphitizable carbon and mixing the joined body particles with graphite particles, the subject involved in each of the carbon materials can be improved.

That is, a) since easily graphitizable carbon is contained, the energy density can be increased and the deterioration of the capacity during storage in the charged state can be decreased.

b) Since volumic expansion/shrinkage of the negative electrode active material accompanying occlusion/release of the lithium ions can be decreased by subject less graphitizable carbon on the surface of easily graphitizable carbon by the mechanochemical treatment, a structure in which the active material layer is less collapsed is obtained, the deterioration of the capacity due to charge/discharge cycles can be improved, and the working life can be improved. c) Since graphite is incorporated, the capacity can be increased and the deterioration of the capacity during storage in the charged state can be decreased.

### Embodiment

Examples of the invention are to be described with reference to examples of manufactured non-aqueous electrolyte secondary batteries.

### 1. Preparation of Positive Electrode

A slurrified solution was prepared by dispersing lithium manganate having an average particle size of 5.8 to 8.6 μm, a graphite powder having an average particle size of 0.5 μm, acetylene black, lithium carbonate, and polyvinylidene fluoride as a binder (manufactured by Kureha Chemical Industry, Co., trade name of product: KF#1120) at a weight ratio of 84.5:9.0:2.0:1.5:3.0 in N-methyl-2-pyrrolidone as a solvent. After coating on the solution as the positive electrode active material layer 2 on both surfaces of an aluminum foil 1 of 15 μm thickness as a positive electrode collector by roll-to-roll transfer and drying them, they were integrated by pressing. The thickness of the positive electrode was set to 85 to 95 μm and the density of the positive electrode active material layers was set to 2.7 g/cm³. If they are pressed further, while the density of the positive electrode active material layer 2 scarcely changes, the positive electrode collector 1 is extended to cause dimensional change. Subsequently, it was cut into 54 mm width and 725 mm length to prepare a rectangular positive electrode.

### 2. Preparation of Negative Electrode

As a negative electrode active material, a powder mixture of easily graphitizable carbon and less graphitizable carbon was at first prepared. The obtained powder mixture was compressively ground to deposit the less graphitizable carbon particles to the surface of the easily graphitizable carbon particles and cause the mechanochemical reaction thereby forming a composite powder 23 as illustrated in FIG. 2. Samples of the composite powder 23 obtained by depositing less graphitizable carbon 22 to easily graphitizable carbon 21 by the mechanochemical treatment were prepared in plurality while changing the weight ratio (easily graphitizable carbon: less graphitizable carbon) in a range from 99.5:0.5 to 90:10. In this embodiment, the powder mixture was compressively ground by using a compression grinding pulverizer (Miracle KCK-32, manufactured by Asada Tekko Co.). The compression grinding pulverizer has a screw feeder having a constant internal space formed therein and continuously supplying a constant amount of easily graphitizable carbon and less graphitizable carbon according to a rotational speed, a fixed blade fixed to a fixing screw of the screw feeder, and a rotational plate. Mechanochemical reaction is taken place by controlling the compression share stress according to the shape of the fixed blade and the rotational blade, the number of rotation, and the amount of each of the powders to be supplied. Composite particles of a structure in which particles of less graphitizable carbon are deposited on the surface of easily graphitizable carbon particles are formed by the reaction. In this example, the compression grinding pulverizer was set to a load current of 18 A, a cooling water temperature to 20° C., and the number of rotation of the main shaft to 70 rpm respectively.

The plural kinds of composite powders and graphite were mixed respectively such that the weight ratio (composite powder:graphite) was within a range of 99:1 to 70:30 respectively to form a negative electrode active material. Polyvinylidene fluoride (manufactured by Kureha Chemical Industry Co.: trade name of products: KF#9130) was added as a binder to the prepared negative electrode active material at a weight ratio of 95:5, and N-methyl-2-pyrrolidone as a solvent was charged and mixed to prepare a slurrified dispersion solution. After coating both surfaces of a copper foil 3 of 10 μm thickness (negative electrode collector) with the dispersion solution by roll-to-roll transfer and drying them, they were integrated by pressing to prepare a negative electrode active material layer 4. While the pressing pressure depends on the type and the mixing ratio of the carbon materials, pressing was performed by setting the pressing pressure in a range not causing dimensional change caused by extension of the negative electrode collector 3. Then, it was cut into 56 mm width and 775 mm length to prepare a rectangular negative electrode.

### 3. Method of Assembling and Testing Battery

FIG. 1 is a schematic cross sectional view of a 18650 type non-aqueous electrolyte secondary battery. An electrode group 15 is formed by spirally winding a positive electrode and a negative electrode by way of a separator 5 comprising a porous polyethylene film having 30 μm thickness and 58.5 mm width. After inserting the electrode group 15 into a battery can 6, one of negative electrode tab terminals 9 was welded to the negative electrode collector 3 and the other of the negative electrode tab terminals 9 was welded to the bottom of the battery can 6. An electrolyte was prepared by using a solvent mixture comprising ethylene carbonate, diethyl carbonate, and dimethyl carbonate at 1:1:1 volume ratio, and dissolving 1 M of LiPF₆ therein, which was injected by 5 mL into a battery container. After welding one of positive electrode tab terminals 8 to the positive electrode collector 1, the other of the positive electrode tab terminals 8 was welded to an upper lid 7. The upper lid 7 was disposed above the battery can 6 by way of an insulating gasket 12 and the portion was caulked to tightly close the battery.

After charging the manufactured non-aqueous electrolyte secondary batteries for 5 hours by a constant voltage of 4.1 V at an ambient temperature of 25° C., it was discharged to a cut-off voltage of 2.7 V at a current value of 1 C to measure an initial discharge capacity. Further, after charging for 5 hours by a constant voltage of 4.1 V at an ambient temperature of 25° C., the discharge capacity was measured after storage for 30 days at an ambient temperature of 50° C. Further, after charge/discharge for 300 cycles within a range of 2.7 V to 4.1 V at a current value of 1 C at an ambient temperature of 50° C., a discharge capacity was measured and a cycle life was evaluated.

Table 1 shows compositions of the non-aqueous electrolyte secondary batteries manufactured in accordance with the examples described above (Example 1 to Example 20). Further, comparative examples (Comparative Example 1 to 4) manufactured for comparison are also shown in Table 1. As shown in Table 1, negative electrodes were formed by using only easily graphitizable carbon in Comparative Example 1, only less graphitizable carbon in Comparative Example 2, and only graphite in Comparative Example 3 respectively, thereby manufacturing non-aqueous electrolyte secondary batteries shown in the preferred embodiments of the invention. In Comparative Example 4, the negative electrode was formed by using a mixture of easily graphitizable carbon, less graphitizable carbon, and graphite with the same composition as that in Example 8, but without applying mechanochemical treatment, thereby manufacturing a non-aqueous electrolyte secondary battery shown in this embodiment.

TABLE 1

| | | Easily | Less | |
|---|---|---|---|---|
| | Presence or absence | graphitizable | graphitizable | |
| | of mechanochemical | carbon | carbon | Graphite |
| | treatment | (parts by weight) | (parts by weight) | (parts by weight) |
| Example 1 | presence | 98.5 | 0.5 | 1 |
| Example 2 | presence | 95 | 4 | 1 |
| Example 3 | presence | 91 | 8 | 1 |
| Example 4 | presence | 89 | 10 | 1 |
| Example 5 | presence | 94.5 | 0.5 | 5 |
| Example 6 | presence | 91 | 4 | 5 |
| Example 7 | presence | 87 | 8 | 5 |
| Example 8 | presence | 85.5 | 9.5 | 5 |
| Example 9 | presence | 89.5 | 0.5 | 10 |
| Example 10 | presence | 86.5 | 3.5 | 10 |
| Example 11 | presence | 83 | 7 | 10 |
| Example 12 | presence | 81 | 9 | 10 |
| Example 13 | presence | 79.5 | 0.5 | 20 |
| Example 14 | presence | 77 | 3 | 20 |
| Example 15 | presence | 73.5 | 6.5 | 20 |
| Example 16 | presence | 72 | 8 | 20 |
| Example 17 | presence | 69.5 | 0.5 | 30 |
| Example 18 | presence | 67 | 3 | 30 |
| Example 19 | presence | 64.5 | 5.5 | 30 |
| Example 20 | presence | 63 | 7 | 30 |
| Comp. | absence | 100 | 0 | 0 |
| Example 1 | | | | |
| Comp. | absence | 0 | 100 | 0 |
| Example 2 | | | | |
| Comp. | absence | 0 | 0 | 100 |
| Example 3 | | | | |
| Comp. | absence | 86.5 | 3.5 | 10 |
| Example 4 | | | | |

Then, manufactured non-aqueous electrolyte secondary batteries of Examples 1 to 20 and Comparative Examples 1 to 4 were evaluated (evaluation 1 to 3). The result of evaluation is shown in Table 2.

TABLE 2

| | | | | Discharge capacity |
|---|---|---|---|---|
| | Less/easily | Discharge | Discharge capacity | retention after |
| | (%) | capacity | retention after storage | operation cycle |
| Example 1 | 0.5 | 99 | 89 | 84 |
| Example 2 | 4.2 | 99 | 88 | 85 |
| Example 3 | 8.8 | 100 | 87 | 86 |
| Example 4 | 11.2 | 101 | 86 | 86 |
| Example 5 | 0.5 | 101 | 90 | 83 |
| Example 6 | 4.4 | 102 | 90 | 85 |
| Example 7 | 9.2 | 102 | 90 | 84 |
| Example 8 | 11.1 | 103 | 87 | 85 |
| Example 9 | 0.6 | 104 | 91 | 83 |
| Example 10 | 4.0 | 104 | 91 | 84 |
| Example 11 | 8.4 | 105 | 90 | 84 |
| Example 12 | 9.9 | 105 | 89 | 85 |
| Example 13 | 0.6 | 109 | 92 | 82 |
| Example 14 | 3.9 | 109 | 92 | 83 |
| Example 15 | 8.8 | 110 | 91 | 83 |
| Example 16 | 11.1 | 110 | 90 | 83 |
| Example 17 | 0.7 | 114 | 92 | 78 |
| Example 18 | 4.5 | 115 | 92 | 81 |
| Example 19 | 8.5 | 115 | 91 | 81 |
| Example 20 | 11.1 | 115 | 89 | 82 |
| Comp. Example 1 | | (Reference)100 | 90 | |
| (easily graphitizable | | | | |
| carbon) | | | | |
| Comp. Example 2 | | 123 | | 82 |
| (less graphitizable | | | | |
| carbon) | | | | |
| Comp. Example 3 | | 154 | 90 | |
| (graphite) | | | | |
| Comp. Example 4 | 4.0 | 106 | 90 | 78 |
| (without | | | | |
| mechanochemical | | | | |
| treatment) | | | | |

### (Evaluation 1: Initial Discharge Capacity)

The manufactured non-aqueous electrolyte secondary batteries, after charging by a constant voltage of 4.1 V at an ambient temperature of 25° C. for 5 hours were discharged to a cut-off voltage of 2.7 V at a current value of 1 C, and initial discharge capacity was measured. The ratio of the initial discharge capacity of the batteries of the respective examples relative to the initial discharge capacity of Comparative Example 1 using only easily graphitizable carbon was determined by percentage. The result is shown in FIG. 3.

FIG. 3 shows plots of the initial discharge capacity in which the discharge capacity relative to the blending ratio of less graphitizable carbon is expressed on every graphite blending ratio. As illustrated in FIG. 3, in the non-aqueous electrolyte secondary batteries of respective examples using a powder mixture of a composite powder formed by application of the mechanochemical treatment and a graphite powder as the negative electrode conductive material, the initial discharge capacity showed values exceeding 100% in the examples at a graphite blending ratio of 5 to 30 mass parts relative to the non-aqueous electrolyte secondary battery of Comparative Example 1 using only easily graphitizable carbon, and it was found that the battery capacity was improved. Further, since the volume of the 18650 type battery was identical in each of the examples, improvement in the energy density of the battery was also confirmed.

(Evaluation 2: Discharge Capacity Retention after Storage)

For the manufactured non-aqueous electrolyte secondary batteries, after charging by a constant voltage of 4.1 V at an ambient temperature of 25° C. for 5 hours, the discharge capacity after storage for 30 days under a circumstance at an ambient temperature of 50° C. was measured. FIG. 4 shows the result of determining the ratio of the discharge capacity after storage relative to the discharge capacity before storage in the respective examples by percentage as the retention discharge capacity by a storage test.

FIG. 4 shows plots for discharge capacity retention after storage in which the discharge capacity retention after storage relative to the blending ratio of less graphitizable graphite is expressed on every blending ratio of graphite. Less graphitizable carbon shows lower capacity retention when stored in the charged state compared with that of graphite and easily graphitizable carbon material. However, as can be seen from the result, the capacity retention of the examples shows a value comparable with that of the Comparative Example 1 using only easily graphitizable carbon and Comparative Example 3 using only graphite. Accordingly, it was found that the degradation of the capacity during storage in the charged state can be decreased in the non-aqueous electrolyte secondary batteries of the respective examples using the powder mixture comprising the composite powder formed by applying the mechanochemical treatment and graphite as the negative electrode conductive material.

Particularly, as apparent from FIG. 4, the long time storability is improved preferably by defining the amount of graphite to 5 mass parts of more. Further, if the weight ratio of the amount of less graphitizable carbon relative to easily graphitizable carbon (weight of graphitizable carbon/weight of easily graphitizable carbon×100) exceeds 10%, the capacity retention was lowered. If the amount of less graphitizable carbon is excessive compared with the amount of easily graphitizable carbon, it may be considered that the characteristics of easily graphitizable carbon is suppressed. Accordingly, it is preferred that the weight ratio of amount of less graphitizable carbon relative to easily graphitizable carbon is preferably 10% or less.

(Evaluation 3: Discharge Capacity Retention after Operation Cycle)

For the manufactured non-aqueous electrolyte secondary batteries, charge/discharge for 300 cycles was performed by a voltage within a range of from 2.7 V to 4.1 V at an ambient temperature of 50° C. and at a current value of 1 C, and the discharge capacity was measured subsequently to evaluate the cycle life. Table 2 and FIG. 5 show the result of determining the ratio of the discharge capacity at the 300th cycle relative to the discharge capacity at the first cycle in each of the examples determined by percentage.

FIG. 5 shows plots of the discharge capacity retention after operation cycles shown in Table 2, in which the discharge capacity retention after operation cycles relative to the blending ratio of less graphitizable carbon is expressed on every blending ratio of graphite.

While materials of easily graphitizable carbon and graphite tend to be deteriorated, less graphitizable carbon is excellent in the durability over the carbon materials described above and it shows about 1.5 times of discharge capacity retention after operation cycle. On the other hand, while the discharge capacity retention after operation cycle in the examples showed the retention equal with or more than that of less graphitizable carbon irrespective of the large content of easily graphitizable carbon and graphite. Accordingly, it was found that degradation of capacity caused by charge/discharge cycles can be decreased according to the constitution of the examples.

Particularly, as shown in FIG. 5, in the non-aqueous electrolyte secondary batteries of the respective examples using the mixture of the composite powder formed by application of the mechanochemical treatment and graphite as the negative electrode conductive material, high discharge capacity retention after operation cycles is shown in the examples in which the blending ratio of less graphitizable carbon was 0.5 mass parts or more, and the blending ratio of graphite was 20 mass parts or less.

FIG. 6 shows plots of the discharge capacity retention after operation cycles of the examples showing high characteristics in the Evaluation 1, Evaluation 2, and Evaluation 3. It can be seen from FIG. 6 that the range for the blending ratio of less graphitizable carbon from 0.5 to 7 mass parts and that for the blending ratio of graphite from 5 to 20 mass parts are preferred as a blending ratio providing high energy density, less deterioration of capacity during storage in the charged state, and excellent in the cycle life characteristics.

As has been described above, a non-aqueous electrolyte secondary battery excellent in battery capacity, cycle life and storage characteristics can be provided by optimizing the mixing ratio between easily graphitizable carbon and less graphitizable carbon, and the mixing ratio between the composite powder and graphite and applying the mechanochemical treatment for easily graphitizable carbon and less graphitizable carbon for the carbon material to be used as the negative electrode active material. This is considered to be attributable to that the capacity can be increased and the deterioration of the capacity during storage can be suppressed by mixing graphite having a large capacity and with less deterioration of the capacity during storage, particles of easily graphitizable carbon are covered with less graphitizable carbon by applying the mechanochemical treatment to less graphitizable carbon on easily graphitizable carbon, and collapse of the carbon structure of easily graphitizable carbon can be protected in charge/discharge cycles by less graphitizable carbon. Further, since the steps of manufacturing the negative electrode according to the examples are simple and easy requiring no substantial change to the existent steps, there is an extremely high industrial applicability.

### LIST OF REFERENCE SIGNS

1 positive electrode collector (aluminum foil)
2 positive electrode active material layer
3 negative electrode collector (copper foil)
4 negative electrode active material layer
5 separator
6 battery can
7 upper lid
8 positive electrode tab terminal
9 negative electrode tab terminal
12 gasket
15 electrode group
20 non-aqueous electrolyte secondary battery

1-6. (canceled)

7. A non-aqueous electrolyte secondary battery including a positive electrode using a transition composite metal oxide containing lithium as a positive electrode active material and a negative electrode using a carbon material as a negative electrode active material in which the positive electrode and the negative electrode are dipped in a non-aqueous electrolyte, and the carbon material contains easily graphitizable carbon and less graphitizable carbon and graphite, wherein
easily graphitizable carbon and less graphitizable carbon form a composite particle, and the composite particle has a structure in which the particle of less graphitizable carbon is deposited to the surface of the easily graphitizable carbon particle.

8. A non-aqueous electrolyte secondary battery according to claim 7 wherein,
the carbon material contains 5 mass % or more of graphite, and the ratio of the weight of less graphitizable carbon to the weight of easily easy graphitizable carbon is 10% or less.

9. A non-aqueous electrolyte secondary battery according to claim 7 wherein,
the carbon material contains 0.5 mass parts or more of less graphitizable carbon and 2.0 mass parts or less of graphite.

10. A non-aqueous electrolyte secondary battery according to claim 8 wherein,
the carbon material contains 0.5 mass parts or more of less graphitizable carbon and 2.0 mass parts or less of graphite.

11. A non-aqueous electrolyte secondary battery according to claim 7 wherein,
the blending ratio of less graphitizable carbon is from 0.5 to 7 mass % and the blending ratio of graphite is from 5 to 20 mass % based on the total weight of easily graphitizable carbon, less graphitizable carbon, and graphite in the carbon material.

12. A non-aqueous electrolyte secondary battery according to claim 7 wherein,
the composite particles are integrated by a mechanochemical treatment.

13. A method of manufacturing a negative electrode for a non-aqueous electrolyte secondary battery, which includes mixing easily graphitizable carbon and less graphitizable carbon and integrating them by applying a mechanochemical treatment, to prepare composite particles preparing a dispersion solution by mixing the composite particles and graphite, and adding a solvent, and
coating the surface of a conductive material with the dispersion solution and drying the coated dispersion solution.
